(19) United States
(12) Patent Application Publication
(10) Pub. No.: US 2019/0316940 A1
(43) Pub. Date: Oct. 17, 2019

(54) MEASUREMENT SYSTEM

(71) Applicant: Frost Control Systems, Inc., South Bend, IN (US)

(72) Inventor: Bradley James Tener, South Bend, IN (US)

(21) Appl. No.: 16/374,618

(22) Filed: Apr. 3, 2019

Related U.S. Application Data
(60) Provisional application No. 62/656,877, filed on Apr. 12, 2018.

(51) Int. Cl. G01D 11/24

(52) U.S. Cl. CPC G01D 11/245

(57) ABSTRACT

A measurement system includes an enclosure having at least one sidewall defining an interior space and at least one opening in the at least one sidewall, and a male insert configured to be coupled to the at least one sidewall of the enclosure. The male insert includes a flange configured to engage an exterior surface of the at least one sidewall around the opening, a stem configured to extend through the opening and into the interior space, and a central opening. The measurement system also includes a female insert configured to be detachably coupled to the male insert inside the interior space, and an opto-electronic sensor configured to be housed inside central opening along the stem of the male insert. The measurement system defines a substantially unobstructed viewport for the opto-electronic sensor.

### CROSS-REFERENCE TO RELATED APPLICATION

This application claims priority to and the benefit of U.S. Provisional Application No. 62/656,877, filed Apr. 12, 2018, the entire contents of which are incorporated herein by reference.

### BACKGROUND

### 1. Field

The present disclosure relates generally to measurement systems.

### 2. Description of the Related Art

Sensors placed outdoors, such as infrared temperature sensors, often require watertight enclosures to protect the sensor and/or the associated circuitry. Infrared temperature sensors are utilized in the winter road maintenance industry to measure road temperature. The measured temperature of the road may be utilized to determine the type and quantity of deicer material to place on the road. Infrared temperature sensors determine the road temperature by measuring the electromagnetic radiation emanating from the road.

In some related art temperature measurement systems including an infrared sensor, the infrared sensor is housed inside the watertight enclosure and the enclosure includes a viewport through which the infrared sensor can measure electromagnetic radiation emanating from the road surface. However, electromagnetic radiation cannot normally pass through glass. Therefore, the viewports in these related art enclosures typically include a crystal lens that allows electromagnetic radiation to pass through the lens. Such crystal lenses are costly, reduce the quality of the temperature measurement by the infrared sensor, and require maintenance to keep the lens free of obstructions, such as dirt, moisture, and ice.

Other related art temperature measurement systems avoid the use of a crystal lens by mounting a temperature sensor on the exterior of an enclosure and sealing related circuitry inside the enclosure. However, in these related art temperature measurement systems, the temperature sensor is permanently affixed to the enclosure. Accordingly, in the event of failure of the temperature sensor, the entire enclosure must be uninstalled and shipped back to the manufacturer while another enclosure is installed. This process is timely and costly because infrared temperature sensors for road temperature monitoring are typically installed on traffic signal mast arms 25 feet above busy intersections and require multiple hours of labor (e.g., electrical work) to install.

Additionally, related art temperature measurement systems utilize heating devices to prevent the formation of ice on the exterior of an enclosure and the lens. Related art systems utilize interior temperature measurements inside the enclosure to estimate the temperature outside the enclosure. These estimates are inaccurate, however, due to exterior influences on the enclosure, such as ambient exterior air temperature.

Moreover, related art temperature measurement systems utilize fans to distribute heat generated by the device to mitigate temperature differentials within the device, which might otherwise cause temperature measurement inaccuracies. However, fans are prone to costly failure due to their mechanical nature, require significant power consumption, and are an expensive component.

### SUMMARY

The present disclosure is directed to various embodiments of a measurement system. In one embodiment, the measurement system includes an enclosure including at least one sidewall defining an interior space and an opening in the at least one sidewall, and a male insert configured to be coupled to the at least one sidewall of the enclosure. The male insert includes a flange configured to engage an exterior surface of the at least one sidewall around the opening, a stem configured to extend through the opening and into the interior space, and a central opening. The measurement system also includes a female insert configured to be detachably coupled to the male insert inside the interior space, and an opto-electronic sensor configured to be housed inside the central opening along the stem of the male insert. The measurement system defines a substantially unobstructed viewport for the opto-electronic sensor.

The flange may be coupled to the exterior surface of the at least one sidewall.

The opto-electronic sensor may be recessed inward from the opening in the at least one sidewall of the enclosure when opto-electronic sensor is housed inside the central opening along the stem of the male insert, the male insert is coupled to the at least one sidewall, and the female insert is coupled to the male insert.

An outer dimension of the male insert may be substantially equal to an inner dimension of the female insert such that when the female insert is detachably coupled to the male insert, a sliding fit is formed between the female insert and the male insert.

The stem of the male insert may include external threads and the female insert may include internal threads configured to threadedly engage the external threads.

The central opening of the male insert may include a tapered segment, and a width of the central opening at the flange may be equal or substantially equal to a width of a sensor observation zone of the opto-electronic sensor at the flange.

The female insert may be coupled to the opto-electronic sensor.

The opto-electronic sensor may be coupled to an inner end of the female insert with a sealing member, and electrical leads may extend from the opto-electronic sensor through one or more openings in the sealing member.

The measurement system may include a sealing member between the flange of the male insert and the exterior surface of the at least one sidewall and extending around the opening in the at least one sidewall when the male insert is coupled to the at least one sidewall.

The sealing member may be an O-ring.

The measurement system may include a sealing member between the female insert and an interior surface of the at least one sidewall and extending around the opening in the at least one sidewall when the male insert is coupled to the at least one sidewall of the enclosure and the female insert is coupled to the male insert.

The opto-electronic sensor may be an infrared temperature sensor, a camera, a LIDAR, a light fidelity (LiFi) sensor, or combinations thereof.

A measurement system according to another embodiment of the present disclosure includes an enclosure including at least one sidewall defining an interior space and an opening in the at least one sidewall, and a male insert configured to be coupled to the at least one sidewall of the enclosure. The male insert includes a flange configured to engage an exterior surface of the at least one sidewall around the opening, a stem configured to extend through the opening and into the interior space, and a central opening. The stem tapers between a narrower end proximate to the flange and a wider end distal to the flange. The measurement system also includes a compression nut configured to be detachably coupled to the male insert inside the interior space, and an opto-electronic sensor configured to be housed inside the central opening along the stem of the male insert. The measurement system defines a substantially unobstructed viewport for the opto-electronic sensor, and when the opto-electronic sensor is in the central opening of the male insert and the compression nut is threaded onto the stem of the male insert, the stem is deflected inward against the opto-electronic sensor.

The flange may be coupled to the exterior surface of the at least one sidewall.

The measurement system may also include a lining in the central opening extending along the stem of the male insert.

The opto-electronic sensor may be recessed from the opening in the at least one sidewall of the enclosure when the opto-electronic sensor is housed inside central opening along the stem of the male insert, the male insert is coupled to the at least one sidewall, and the compression nut is coupled to the male insert.

The opto-electronic sensor may be an infrared temperature sensor, a camera, a LIDAR, a light fidelity (LiFi) sensor, or combinations thereof.

The central opening of the male insert may include a tapered segment, and a width of the central opening at the flange may be equal or substantially equal to a width of a sensor observation zone of the opto-electronic sensor at the flange.

The measurement system may also include a sealing member between the flange of the male insert and the exterior surface of the at least one sidewall and extending around the opening in the at least one sidewall when the male insert is coupled to the at least one sidewall.

A measurement system according to a further embodiment of the present disclosure includes an enclosure including at least one sidewall defining an interior space and an opening in the at least one sidewall, and a male insert configured to be coupled to the at least one sidewall of the enclosure. The male insert includes a stem and a central opening. The measurement system also includes a female insert or a compression nut configured to be detachably coupled to the male insert inside the interior space, and an opto-electronic sensor configured to be housed inside the central opening along the stem of the male insert. The stem of the male insert extends into the interior space from the at least one sidewall when the male insert is coupled to the at least one sidewall. The central opening of the male insert is at least partially aligned with the opening in the at least one sidewall when the male insert is coupled to the at least one sidewall. The measurement system defines a substantially unobstructed viewport for the opto-electronic sensor.

This summary is provided to introduce a selection of concepts that are further described below in the detailed description. This summary is not intended to identify key or essential features of the claimed subject matter, nor is it intended to be used in limiting the scope of the claimed subject matter. One or more of the described features may be combined with one or more other described features to provide a workable device.

### BRIEF DESCRIPTION OF THE DRAWINGS

The features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIGS. 1A-1C are cross-sectional views of a measurement system, a male insert of the measurement system, and a female insert and a sensor of the measurement system, respectively, according to one embodiment of the present disclosure;

FIGS. 2A-2B are an assembled cross-sectional view and a partially exploded cross-sectional view, respectively, of a measurement system according to another embodiment of the present disclosure;

FIGS. 3A-3B are an assembled cross-sectional view and a partially exploded cross-sectional view, respectively, of a measurement system according to a further embodiment of the present disclosure; and

FIG. 4 is a cross-sectional view of a male insert according to one embodiment of the present disclosure.

### DETAILED DESCRIPTION

The present disclosure is directed to various embodiments of a measurement system. In one or more embodiments, the measurement system is a temperature measurement system configured to perform road temperature measurements. Road temperature measurements are utilized in the winter road maintenance industry to determine, for instance, the type and/or quantity of deicer material to place on the road. In one or more embodiments, the temperature measurement system of the present disclosure is configured to enable convenient and cost-effective servicing of the temperature sensor and eliminates the need for costly crystal viewport lenses. Additionally, in one or more embodiments, the measurement system (e.g., the temperature measurement system) of the present disclosure is provided without a fan for evenly distributing heat within an enclosure of the system, which makes the measurement systems of the present disclosure less prone to failure and less costly to manufacture and operate than related art measurement systems that include a fan.

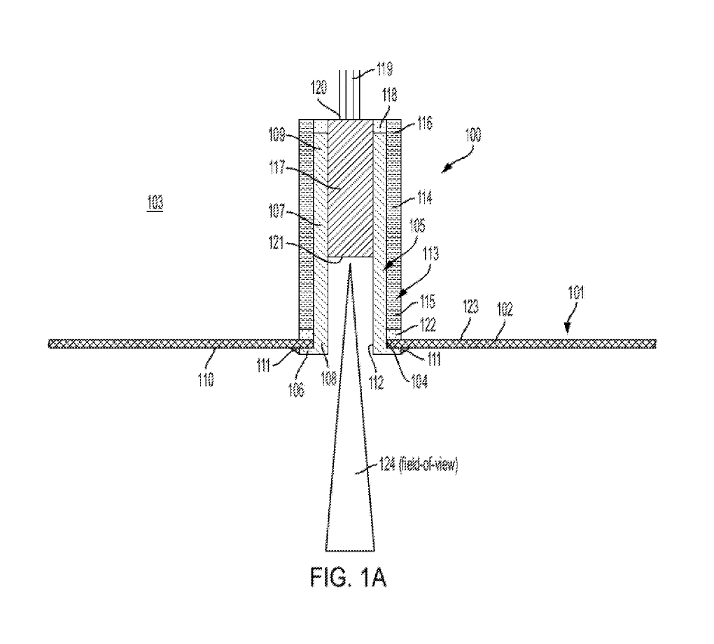

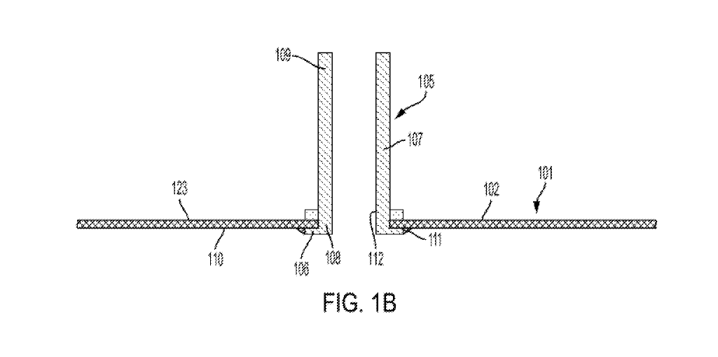

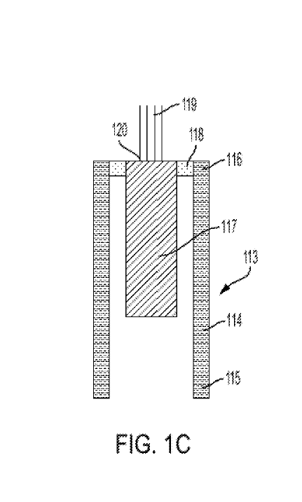

With reference now to FIGS. 1A-1C, a measurement system 100 according to one embodiment of the present disclosure includes an enclosure 101 (e.g., a case) configured to house one or more electronic components for analyzing, storing, and/or transmitting data (e.g., temperature data) measured by the measurement system 100. The enclosure 101 includes at least one sidewall 102 defining an interior space 103 (e.g., an interior chamber), and an opening 104 is defined in the sidewall 102 of the enclosure 101. In one or more embodiments, the measurement system 100 may be configured to measure one or more conditions, such as the temperature of a road.

With continued reference to FIGS. 1A-1C, the measurement system 100 includes a male insert 105. The male insert 105 includes a flange 106 and a stem 107 extending from the flange 106. The stem 107 of the male insert 105 includes an outer end 108 proximate to the flange 106 and an inner end 109 distal to the flange 106. In the illustrated embodiment, the flange 106 extends outward (e.g., radially outward) from the outer end 108 of the stem 107. In the illustrated embodiment, when the measurement system 100 is assembled, the flange 106 of the male insert 105 is coupled (e.g., fixedly coupled) to an exterior surface 110 of the sidewall 102 around the opening 104 in the sidewall 102. Additionally, in the illustrated embodiment, the flange 106 of the male insert 105 is sealed to the exterior surface 110 of the sidewall 102 of the enclosure 101 with sealant 111 (e.g., silicone sealant). In the illustrated embodiment, the sealant 111 extends around an outer periphery of the flange 106. The sealant 111 is configured to form a fluid-tight seal between the flange 106 of the male insert 105 and the sidewall 102 of the enclosure 101. Additionally, in the illustrated embodiment, when the measurement system 100 is assembled, the stem 107 of the male insert 105 extends through the opening 104 in the sidewall 102 of the enclosure 101 and into the interior space 103. In the illustrated embodiment, the stem 107 is a hollow cylindrical member, and the flange 106 is an annular member, although in one or more embodiments, the flange 106 and the stem 107 of the male insert 105 may have any other suitable shapes. The male insert 105 defines a central opening 112 (e.g., a through hole) extending through the flange 106 and the stem 107. In one or more embodiments, the flange 106 of the male insert 105 may be coupled to an interior surface of the sidewall 102 opposite the exterior surface 110 around the opening 104 in the sidewall 102.

In the illustrated embodiment, the measurement system 100 also includes a female insert 113 (see FIGS. 1A and 1C). The female insert 113 includes a sidewall 114 having an outer end 115 and an inner end 116 opposite the outer end 115. The female insert 113 is configured to be detachably coupled to the stem 107 of the male insert 105 inside the interior space 103 of the enclosure 101. In the illustrated embodiment, the female insert 113 is a hollow cylindrical member, although in one or more embodiments the female insert 113 may have any other suitable shape. Additionally, in the illustrated embodiment, an inner dimension of the sidewall 114 of the female insert 113 is equal or substantially equal to an outer dimension of the stem 107 of the male insert 105 (e.g., an inner diameter of the sidewall 114 of the female insert 113 is equal or substantially equal to an outer diameter of the stem 107 of the male insert 105). In one or more embodiments, the inner dimension of the sidewall 114 of the female insert 113 (e.g., the inner diameter of the sidewall 114 of the female insert 113) and the outer dimension of the stem 107 of the male insert 105 (e.g., the outer diameter of the stem 107 of the male insert 105) may be precisely toleranced such that there is, for example, a location fit or a sliding fit between the female insert 113 and the stem 107 of the male insert 105.

In the illustrated embodiment, the measurement system 100 also includes a sensor 117 (e.g., an opto-electronic sensor) coupled to the female insert 113. The sensor 117 may be any suitable type or kind of sensor depending on the one or more conditions the measurement system 100 is configured to measure. For instance, in one or more embodiments, the sensor 117 may be a temperature sensor (e.g., an infrared thermometer), one or more cameras, a light detection and ranging (LIDAR) sensor, and/or a light fidelity (LiFi) sensor. In the illustrated embodiment, the sensor 117 is housed in an interior of the female insert 113. Additionally, in the illustrated embodiment, the sensor 117 is coupled to the female insert 113 proximate to the inner end 116 of the female insert 113 with a sealing member 118 (e.g., a rubber O-ring). One or more electrical leads 119 extend from the sensor 117 through one or more openings 120 in the sealing member 118. The leads 119 are configured to be connected to one or more electrical devices housed in the interior space 103 of the enclosure 101 for processing, recording, and/or transmitting the data (e.g., the temperature data) measured or determined by the sensor 117.

When the female insert 113 is coupled to the male insert 105, as illustrated in FIG. 1A, the sensor 117 extends into the interior of the stem 107 of the male insert 105. In the illustrated embodiment, an outer dimension (e.g., an outer diameter) of the sensor 117 is the same or substantially the same as an inner dimension (e.g., an inner diameter) of the stem 107 of the male insert 105 such that a fluid-tight seal is formed between the sensor 117 and the stem 107 of the male insert 105. In one or more embodiments, a gasket or other sealing member may be provided between an outer surface of the sensor 117 and an inner surface of the stem 107 of the male insert 105.

Additionally, in the illustrated embodiment, when the female insert 113 is coupled to the male insert 105, the sensor 117 is recessed inward from the flange 106 of the male insert 105 and the opening 104 in the sidewall 102 of the enclosure 101 (e.g., a length of the stem 107 of the male insert 105 is longer than a length of the sensor 117). Additionally, in the illustrated embodiment, only a measurement end 121 of the sensor 117 is exposed to the elements (e.g., only the measurement end 121 of the sensor 117 is in fluid communication with an exterior of the enclosure 101). Recessing the sensor 117 inward from the flange 106 of the male insert 105 and the opening 104 in the sidewall 102 of the enclosure 101 is configured to protect the sensor 117 from adverse conditions outside of the enclosure 101, which might otherwise damage the sensor 117 and/or adversely affect the accuracy of the measurements taken by the sensor 117.

Additionally, in the illustrated embodiment, when the measurement system 100 is assembled, the measurement system 100 also includes a sealing member 122 (e.g., a rubber O-ring) between the outer end 115 of the female insert 113 and an interior surface 123 of the sidewall 102 around the opening 104. The female insert 113 is configured to press the sealing member 122 against the interior surface 123 of the sidewall 102 when the female insert 113 is coupled to the male insert 105, as illustrated in FIG. 1A. The sealant 111 and the pair of sealing members 118, 122 (e.g., the pair of rubber O-rings) are configured to create fluid-tight seals that prevent or at least mitigate the introduction of water or other contaminants into the interior space 103 of the enclosure 101, which might otherwise damage the electronics housed therein.

In the event of a failure of the sensor 117, the sensor 117 may be removed (e.g., for replacement or repair) by detaching the female insert 113 from the male insert 105 inside the interior space 103 of the enclosure 101. In this manner, the measurement system 100 is readily serviceable.

In one or more embodiments in which the sensor 117 is an infrared thermometer (i.e., a temperature sensor), the temperature sensor 117 is configured to measure the temperature of an object (e.g., a road) by detecting electromagnetic radiation in the far infrared spectral range emanating from the object. In the illustrated embodiment, the temperature sensor 117 has a sensor observation zone 124 (e.g., a field-of-view) (see FIG. 1A) in which the temperature sensor 117 is configured to detect electromagnetic radiation. In the illustrated embodiment, the sensor observation zone 124 of the temperature sensor 117 is unobstructed (e.g., the temperature measurement system 100 is provided without a lens or other obstructive component between the temperature sensor 117 and the opening 104 in the sidewall 102 of the enclosure 101). That is, the sensor observation zone 124 of the sensor 117, which originates from the measurement end 121 of the sensor 117, does not pass through a lens or other obstructive component between the temperature sensor 117 and the opening 104 in the sidewall 102 of the enclosure 101. In this manner, the measurement system 100 of the present disclosure provides or defines an unobstructed or substantially unobstructed viewport for the sensor 117. Accordingly, the measurement system 100 of the present disclosure is less costly than related art temperature measurement systems that include a costly crystal lens through which electromagnetic radiation passes to reach the infrared temperature sensor.

In one or more embodiments, the male insert 105 and/or the female insert 113 may be formed of a thermally conductive material, such as copper. In one or more embodiments, the male and female inserts 105, 113 may be utilized to determine or estimate the exterior temperature outside of the enclosure 101. For instance, in one or more embodiments in which the male insert 105 is formed of a thermally conductive material (e.g., copper), the temperature sensor 117 may be utilized to measure the temperature of the male insert 105, which is in contact (e.g., direct contact) with the exterior surface 110 of the sidewall 102 of the enclosure 101. Measuring or determining the exterior temperature outside of the enclosure 101 may be utilized to control a heating system of the measurement system 100 configured to prevent or mitigate the formation on ice on the exterior of the enclosure 101. Additionally, the thermally conductive material of the male insert 105 is configured to prevent the formation of thermal gradients (e.g., thermal differentials) in the male insert 105, which might otherwise cause inaccuracies in determining the exterior temperature outside of the enclosure 101. Accordingly, unlike related art measurement systems that estimate the exterior temperature by measuring the interior temperature inside the enclosure of the measurement system, which requires utilizing one or more fans or other electromechanical devices to evenly distribute heat generated by the measurement system and thereby mitigate temperature differentials within the measurement system, in one or more embodiments, the measurement system 100 of the present disclosure may be provided without one or more fans or other electromechanical devices for evenly distributing heat within the enclosure 101.

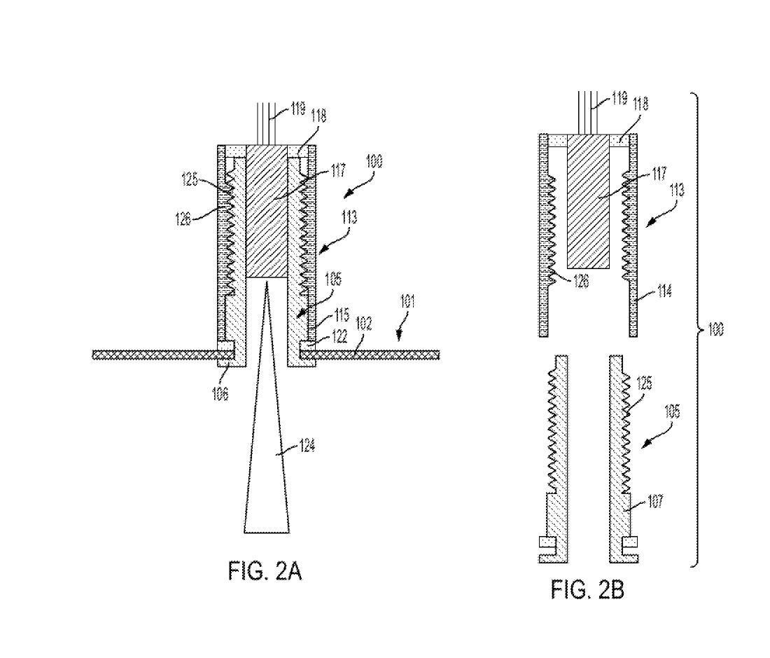

The female insert 113 may be configured to be detachably coupled to the male insert 105 in any suitable manner. In one or more embodiment, the inner dimension of the female insert 113 and the outer dimension of the stem 107 of the male insert 105 may be precisely toleranced such that there is, for example, a location fit or a sliding fit between the stem 107 of the male insert 105 and the female insert 113. In the embodiment illustrated in FIGS. 2A-2B, an outer surface the stem 107 of the male insert 105 includes threads 125, and an inner surface of the sidewall 114 of the female insert 113 defines corresponding threads 126 configured to threadedly engage the threads 125 of the male insert 105. Rotation of the female insert 113 relative to the male insert 105 in this configuration draws the flange 106 against the exterior surface 110 of the sidewall 102 of the enclosure 101 and presses the sealing member 122, with the outer end 115 of the female insert 113, against the inner surface 123 of the sidewall 102 of the enclosure 101. In this manner, the threaded engagement between the threads 125 of the male insert 105 and the threads 126 of the female insert 113 clamps the sidewall 102 of the enclosure 101 between the flange 106 of the male insert 105 and the outer end 115 of the female insert 113 and thereby couples (e.g., secures) the male and female inserts 105, 113 and the sensor 117 to the sidewall 102 of the enclosure 101.

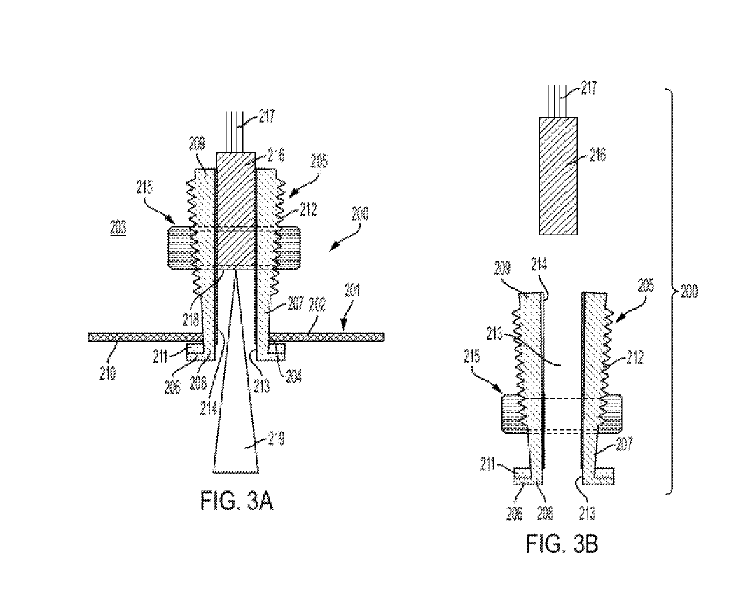

With reference now to FIGS. 3A-3B, a measurement system 200 according to another embodiment of the present disclosure includes an enclosure 201 (e.g., a case) including at least one sidewall 202 defining an interior space 203 (e.g., an interior chamber) configured to house one or more electronic components for analyzing and/or storing data (e.g., temperature data) measured by the measurement system 200. An opening 204 is defined in the sidewall 202 of the enclosure 201. In one or more embodiments, the measurement system 200 may be configured to measure one or more conditions, such as the temperature of a road.

In the embodiment illustrated in FIGS. 3A-3B, the measurement system 200 includes a male insert 205 including a flange 206 and a stem 207 extending from the flange 206. The stem 207 of the male insert 205 includes an outer end 208 proximate to the flange 206 and an inner end 209 distal to the flange 206. In the illustrated embodiment, the stem 207 extends outward (e.g., radially outward) from the inner end 209 of the stem 207. The flange 206 of the male insert 205 is coupled (e.g., fixedly coupled) to an exterior surface 210 of the sidewall 202 around the opening 204. In the illustrated embodiment, a sealing member 211 (e.g., a rubber O-ring) is disposed between the flange 206 of the male insert 205 and the exterior surface 210 of the sidewall 202 of the enclosure 201. Additionally, in one or more embodiments, the flange 206 of the male insert 205 may be sealed to the exterior surface 210 of the sidewall 202 of the enclosure 201 with a sealant (e.g., silicone sealant). The sealing member 211 is configured to form a fluid-tight seal between the flange 206 of the male insert 205 and the sidewall 202 of the enclosure 201. In the illustrated embodiment, when the measurement system 200 is assembled, the stem 207 of the male insert 205 extends through the opening 204 in the sidewall 202 of the enclosure 201 and into the interior space 203. In the illustrated embodiment, the stem 207 is a hollow cylindrical member, and the flange 206 is an annular member, although in one or more embodiments, the flange 206 and the stem 207 of the male insert 205 may have any other suitable shapes.

In the illustrated embodiment, the inner end 209 of the stem 207 is wider than the outer end 208 of the stem 207 and the male insert 205 has a frusto-conical shape tapering between the relatively narrower outer end 208 proximate to the flange 206 and the relatively wider inner end 209 distal to the flange 206 (e.g., the stem 207 of the male insert 205 has a relatively smaller outer diameter at the outer end 208 and a relatively larger outer diameter at the inner end 209). In the illustrated embodiment, an outer surface of the stem 207 (or at least a portion thereof) of the male insert 205 includes threads 212.

In the illustrated embodiment, the male insert 205 defines a central opening 213 (e.g., a through hole) extending through the flange 206 and the stem 207. Additionally, in the illustrated embodiment, the central opening 213 is straight or substantially straight, although in one or more embodiments, the central opening 213 may taper.

In the illustrated embodiment, the temperature measurement system 200 also includes a lining 214 (e.g., a rubber lining or gasket) in the central opening 213 and extending along at least a portion of the inner surface of the central opening 213 along the stem 207 of the male insert 205.

In the illustrated embodiment, the measurement system 200 also includes a compression nut 215 configured to be threaded onto the threads 212 of the stem 207 of the male insert 205.

In the illustrated embodiment, the measurement system 200 also includes a sensor 216 (e.g., an opto-electronic sensor). The sensor 216 may be any suitable type or kind of sensor depending on the one or more conditions the measurement system 200 is configured to measure. For instance, in one or more embodiments, the sensor 216 may be a temperature sensor (e.g., an infrared thermometer), one or more cameras, a LIDAR sensor, and/or a LiFi sensor. To attach the sensor 216 to the male insert 205, the sensor 216 is inserted at least partially into the central opening 213 of the male insert 205 and then the compression nut 215 is threaded onto the threads 212 of the stem 207 of the male insert 205. As the compression nut 215 is threaded onto the threads 212 of the stem 207 of the male insert 205, the stem 207 is deflected radially inward, due to the tapered configuration of the stem 207, and the lining 214 is pressed against the sensor 216. The engagement between the lining 214 and the sensor 216 creates a liquid-tight seal. One or more electrical leads 217 extend from the sensor 216 and are configured to be connected to one or more electrical devices housed in the interior space 203 of the enclosure 201 for processing and/or recording the data (e.g., the temperature data) measured or determined by the sensor 216.

In the illustrated embodiment, when the compression nut 215 is threadedly coupled to the stem 207 of the male insert 205, the sensor 216 is recessed from the flange 206 of the male insert 205 and the opening 204 in the sidewall 202 of the enclosure 201. Accordingly, in the illustrated embodiment, only a measurement end 218 of the sensor 216 is exposed to the elements.

In the event of a failure of the sensor 216, the sensor 216 may be removed by detaching (e.g., unthreading) the compression nut 215 from the male insert 205 inside the interior space 203 of the enclosure 201, and sliding the sensor 216 out of the central opening 213 in the male insert 205. In this manner, the measurement system 200 is readily serviceable.

In one or more embodiments in which the sensor 216 is an infrared thermometer (i.e., a temperature sensor), the temperature sensor 216 is configured to measure the temperature of an object (e.g., a road) by detecting electromagnetic radiation in the far infrared spectral range emanating from the object. In the illustrated embodiment, the temperature sensor 216 has a sensor observation zone 219 (e.g., a field-of-view) in which the temperature sensor 216 is configured to detect electromagnetic radiation. In the illustrated embodiment, the sensor observation zone 219 of the temperature sensor 216 is unobstructed (e.g., the temperature measurement system 200 is provided without a lens or other obstructive component between the temperature sensor 216 and the opening 204 in the sidewall 202 of the enclosure 201). That is, the sensor observation zone 219 of the sensor 216, which originates from the measurement end 218 of the sensor 216, does not pass through a lens or other obstructive component between the temperature sensor 216 and the opening 204 in the sidewall 202 of the enclosure 201. In this manner, the measurement system 200 of the present disclosure provides or defines an unobstructed or substantially unobstructed viewport for the sensor 216. Accordingly, the measurement system 200 of the present disclosure is less costly than related art temperature measurement systems that include a costly crystal lens through which electromagnetic radiation passes to reach the infrared temperature sensor.

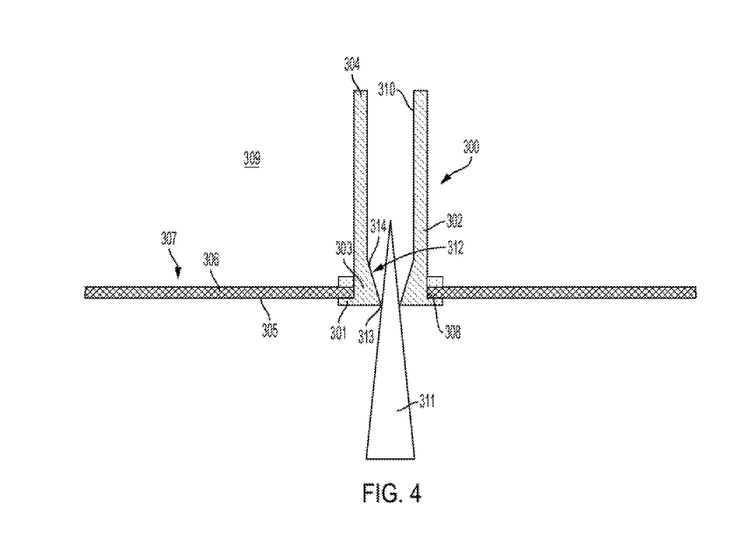

With reference now to FIG. 4, a male insert 300 according to one embodiment of the present disclosure includes a flange 301 and a stem 302 extending from the flange 301. The stem 302 of the male insert 300 includes an outer end 303 proximate to the flange 301 and an inner end 304 distal to the flange 301. In the illustrated embodiment, the stem 302 extends outward (e.g., radially outward) from the inner end 304 of the stem 302. When assembled, the flange 301 of the male insert 300 is coupled (e.g., fixedly coupled) to an exterior surface 305 of a sidewall 306 of an enclosure 307 (e.g., a case). The stem 302 of the male insert 300 extends through an opening 308 in the sidewall 306 of the enclosure 307 and into an interior space 309 of the enclosure 307. In the illustrated embodiment, the stem 302 is a hollow cylindrical member, and the flange 301 is an annular member, although in one or more embodiments, the flange 301 and the stem 302 of the male insert 300 may have any other suitable shapes.

In the illustrated embodiment, the male insert 300 defines a central opening 310 extending through the flange 301 and the stem 302. Additionally, in the illustrated embodiment, the width of the central opening 310 narrows at the outer end 303 of the stem 302 proximate to the flange 301. In one or more embodiments, when a sensor (e.g., a temperature sensor) is housed inside the central opening 310 of the male insert 300, the width of the central opening 310 at the flange 301 is equal or substantially equal to the width of a sensor observation zone 311 (e.g., a field-of-view) of the sensor at the flange 301. Constricting the width of the central opening 310 is configured to reduce the possibility of debris entering the central opening 310. Additionally, in the illustrated embodiment, the central opening 310 includes a tapered segment 312 that tapers from a relatively wider portion 313 to a relatively narrower portion 314 in an outward direction. The tapered segment 312 of the central opening 310 is configured to cause moisture that condensates on the male insert 300 to flow out of the central opening 310 in the male insert 300. In one or more embodiments, the tapered segment 312 may be smooth or may include one or more steps.

The embodiment of any of the male inserts disclosed herein (e.g., the embodiment of the male insert 105 illustrated in FIGS. 1A-1C and 2B-2B and/or the embodiment of the male insert 205 illustrated in FIGS. 3A-3B) may include a narrowing central opening 310 as illustrated in FIG. 4.

While this invention has been described in detail with particular references to embodiments thereof, the embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention. Although relative terms such as “horizontal,” “vertical,” “upper,” “lower,” “inner,” “outer” and similar terms have been used herein to describe a spatial relationship of one element to another, it is understood that these terms are intended to encompass different orientations of the various elements and components of the invention in addition to the orientation depicted in the figures. Additionally, as used herein, the term “substantially” and similar terms are used as terms of approximation and not as terms of degree, and are intended to account for the inherent deviations in measured or calculated values that would be recognized by those of ordinary skill in the art. Furthermore, as used herein, when a component is referred to as being “on” or “coupled to” another component, it can be directly on or attached to the other component or intervening components may be present therebetween.

What is claimed is:

1. A measurement system, comprising:
an enclosure comprising at least one sidewall defining an interior space and an opening in the at least one sidewall;
a male insert configured to be coupled to the at least one sidewall of the enclosure, the male insert comprising a flange configured to engage an exterior surface of the at least one sidewall around the opening, a stem configured to extend through the opening and into the interior space, and a central opening;
a female insert configured to be detachably coupled to the male insert inside the interior space; and
an opto-electronic sensor configured to be housed inside the central opening along the stem of the male insert,
wherein the measurement system defines a substantially unobstructed viewport for the opto-electronic sensor.

2. The measurement system of claim 1, wherein the flange is coupled to the exterior surface of the at least one sidewall.

3. The measurement system of claim 1, wherein the opto-electronic sensor is recessed inward from the opening in the at least one sidewall of the enclosure when opto-electronic sensor is housed inside the central opening along the stem of the male insert, the male insert is coupled to the at least one sidewall, and the female insert is coupled to the male insert.

4. The measurement system of claim 1, wherein an outer dimension of the male insert is substantially equal to an inner dimension of the female insert, and wherein, when the female insert is detachably coupled to the male insert, a sliding fit is formed between the female insert and the male insert.

5. The measurement system of claim 1, wherein the stem of the male insert comprises external threads and wherein the female insert comprises internal threads configured to threadedly engage the external threads.

6. The measurement system of claim 1, wherein the central opening of the male insert comprises a tapered segment, and wherein a width of the central opening at the flange is equal or substantially equal to a width of a sensor observation zone of the opto-electronic sensor at the flange.

7. The measurement system of claim 1, wherein the female insert is coupled to the opto-electronic sensor.

8. The measurement system of claim 7, wherein the opto-electronic sensor is coupled to an inner end of the female insert with a sealing member, and wherein electrical leads extend from the opto-electronic sensor through one or more openings in the sealing member.

9. The measurement system of claim 1, further comprising a sealing member between the flange of the male insert and the exterior surface of the at least one sidewall and extending around the opening in the at least one sidewall when the male insert is coupled to the at least one sidewall.

10. The measurement system of claim 9, wherein the sealing member is an O-ring.

11. The measurement system of claim 1, further comprising a sealing member between the female insert and an interior surface of the at least one sidewall and extending around the opening in the at least one sidewall when the male insert is coupled to the at least one sidewall of the enclosure and the female insert is coupled to the male insert.

12. The measurement system of claim 1, wherein the opto-electronic sensor is selected from the group of sensors consisting of an infrared temperature sensor, a camera, a LIDAR, a light fidelity (LiFi) sensor, and combinations thereof.

13. A measurement system, comprising:
an enclosure comprising at least one sidewall defining an interior space and an opening in the at least one sidewall;
a male insert configured to be coupled to the at least one sidewall of the enclosure, the male insert comprising a flange configured to engage an exterior surface of the at least one sidewall around the opening, a stem configured to extend through the opening and into the interior space, and a central opening, the stem tapering between a narrower end proximate to the flange and a wider end distal to the flange;
a compression nut configured to be detachably coupled to the male insert inside the interior space; and
an opto-electronic sensor configured to be housed inside the central opening along the stem of the male insert,
wherein the measurement system defines a substantially unobstructed viewport for the opto-electronic sensor, and
wherein, when the opto-electronic sensor is in the central opening of the male insert and the compression nut is threaded onto the stem of the male insert, the stem is deflected inward against the opto-electronic sensor.

14. The measurement system of claim 13, wherein the flange is coupled to the exterior surface of the at least one sidewall.

15. The measurement system of claim 13, further comprising a lining in the central opening extending along the stem of the male insert.

16. The measurement system of claim 13, wherein the opto-electronic sensor is recessed from the opening in the at least one sidewall of the enclosure when the opto-electronic electric sensor is housed inside central opening along the stem of the male insert, the male insert is coupled to the at least one sidewall, and the compression nut is coupled to the male insert.

17. The measurement system of claim 13, wherein the opto-electronic sensor is selected from the group of sensors consisting of an infrared temperature sensor, a camera, a LIDAR, a light fidelity (LiFi) sensor, and combinations thereof.

18. The measurement system of claim 13, wherein the central opening of the male insert comprises a tapered segment, and wherein a width of the central opening at the flange is equal or substantially equal to a width of a sensor observation zone of the opto-electronic sensor at the flange.

19. The measurement system of claim 13, further comprising a sealing member between the flange of the male insert and the exterior surface of the at least one sidewall and extending around the opening in the at least one sidewall when the male insert is coupled to the at least one sidewall.

20. A measurement system, comprising:
an enclosure comprising at least one sidewall defining an interior space and an opening in the at least one sidewall;
a male insert configured to be coupled to the at least one sidewall of the enclosure, the male insert comprising a stem and a central opening;
one of a female insert or a compression nut configured to be detachably coupled to the male insert inside the interior space; and
an opto-electronic sensor configured to be housed inside the central opening along the stem of the male insert,
wherein the stem of the male insert extends into the interior space from the at least one sidewall when the male insert is coupled to the at least one sidewall,
wherein the central opening of the male insert is at least partially aligned with the opening in the at least one sidewall when the male insert is coupled to the at least one sidewall, and
wherein the measurement system defines a substantially unobstructed viewport for the opto-electronic sensor.
